(19) United States
(12) Patent Application Publication
(10) Pub. No.: US 2004/0051009 A1
(43) Pub. Date: Mar. 18, 2004

(54) Extensible leg frame

(76) Inventor: Kao-San Chen, Taichung (TW)

Correspondence Address: KOA-SAN CHEN, NO. 2 ALLEY 492, HAI TEIN ROAD SEC. 2, TAINAN, TW

(21) Appl. No.: 10/251,869

(22) Filed: Sep. 17, 2002

(51) Int. Cl. F16M 11/00

(52) U.S. Cl. 248/163.1; 248/164; 248/432; 248/166; 248/440.1

(57) ABSTRACT

An extensible leg frame has four support rods, four tubes, four hollow joints, four bottom seats, and eight connection rods. Each hollow joint is disposed on a top end of the corresponding support rod. Each tube is disposed on the corresponding bottom seat. Each support rod is inserted through the corresponding tube. Each connection rod is connected to the corresponding hollow joint and the corresponding bottom seat. Each support rod has a round aperture. Each hollow joint has a plurality of circular apertures. A rivet fastens the corresponding hollow joint and the corresponding support rod together.

### BACKGROUND OF THE INVENTION

The present invention relates to an extensible leg frame. More particularly, the present invention relates to an extensible leg frame for a table or a foldable chair.

Referring to FIGS. 1 and 2, a conventional extensible leg frame 1 has four leg rods 11, four pivot joints 12, four movable collars 13, and eight connection rods 14. Each pivot joint 12 is disposed on a top end of the corresponding leg rod 11. Each movable collar 13 surrounds the corresponding leg rod 11. Each connection rod 14 is connected to the corresponding pivot joint 12 and the corresponding movable collar 13. However, a center of gravity of the conventional extensible leg frame 1 will be moved upward while the conventional extensible leg frame 1 is extended. Therefore, the conventional extensible leg frame 1 will stand unstably. When the conventional extensible leg frame 1 is bumped by a user, the conventional extensible leg frame 1 will be collapsed.

### SUMMARY OF THE INVENTION

An object of the present invention is to provide an extensible leg frame which stands stably while the extensible leg frame is extended. A center of gravity of the extensible leg frame is lowered. When the extensible leg frame is bumped by a user, the extensible leg frame will not be collapsed easily.

Accordingly, an extensible leg frame comprises four support rods, four tubes, four hollow joints, four bottom seats, and eight connection rods. Each hollow joint is disposed on a top end of the corresponding support rod. Each tube is disposed on the corresponding bottom seat. Each support rod is inserted through the corresponding tube. Each connection rod is connected to the corresponding hollow joint and the corresponding bottom seat. Each support rod has a round aperture. Each hollow joint has a plurality of circular apertures. A rivet fastens the corresponding hollow joint and the corresponding support rod together.

### BRIEF DESCRIPTION OF THE DRAWINGS

FIG. 1 is a perspective view of a conventional extensible leg frame of the prior art;

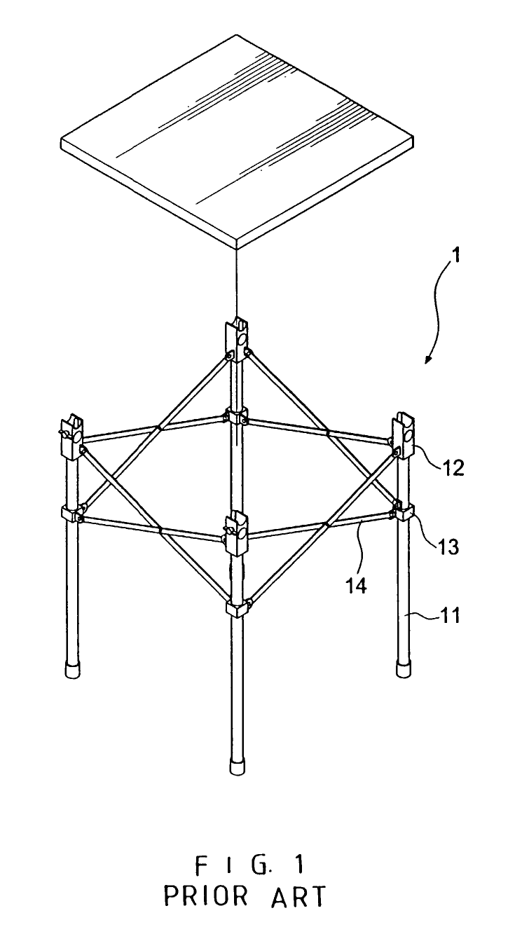

FIG. 2 is a schematic view illustrating a folding of a conventional extensible leg frame of the prior art;

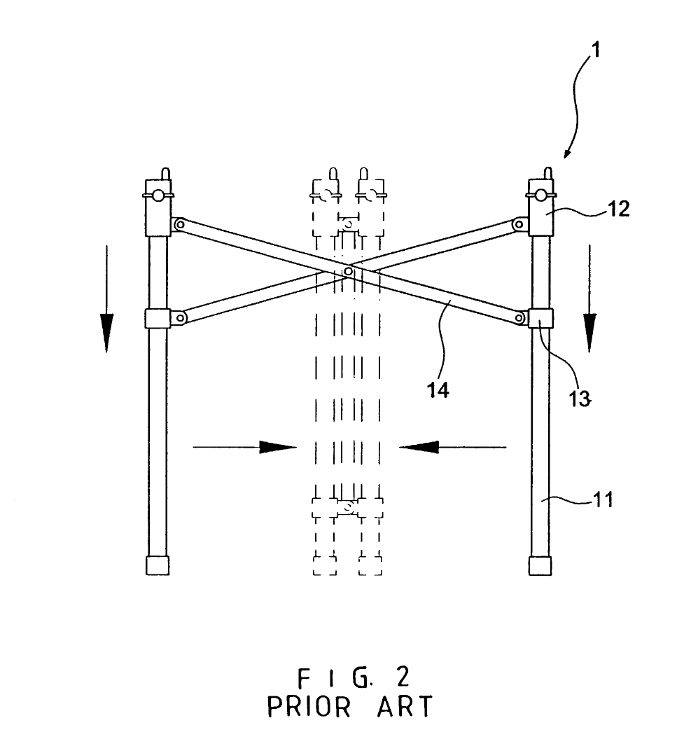

FIG. 3 is a perspective view of an extensible leg frame of a first preferred embodiment in accordance with the present invention;

FIG. 4 is a partially perspective exploded view of an extensible leg frame of a first preferred embodiment in accordance with the present invention;

FIG. 5 is a sectional schematic view illustrating an operation of an extensible leg frame of a first preferred embodiment in accordance with the present invention;

FIG. 6 is a perspective schematic view illustrating an operation of an extensible leg frame of a first preferred embodiment in accordance with the present invention;

FIG. 7 is a schematic view illustrating a folding of an extensible leg frame of a first preferred embodiment in accordance with the present invention;

FIG. 8 is a partially sectional assembly view of an extensible leg frame of a second preferred embodiment in accordance with the present invention;

FIG. 9 is a partially sectional assembly view of an extensible leg frame of a third preferred embodiment in accordance with the present invention; and

FIG. 10 is a schematic view illustrating a chair seat disposed on an extensible leg frame of a first preferred embodiment in accordance with the present invention.

### DETAILED DESCRIPTION OF THE INVENTION

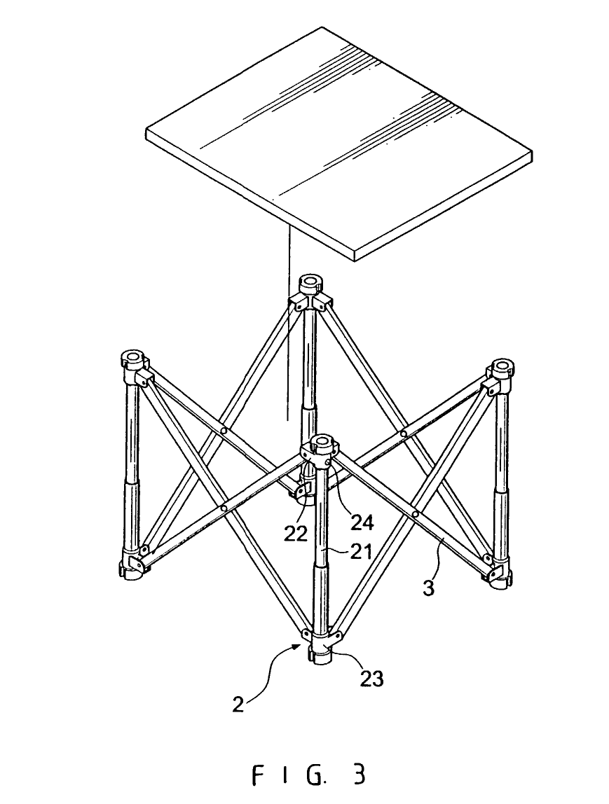

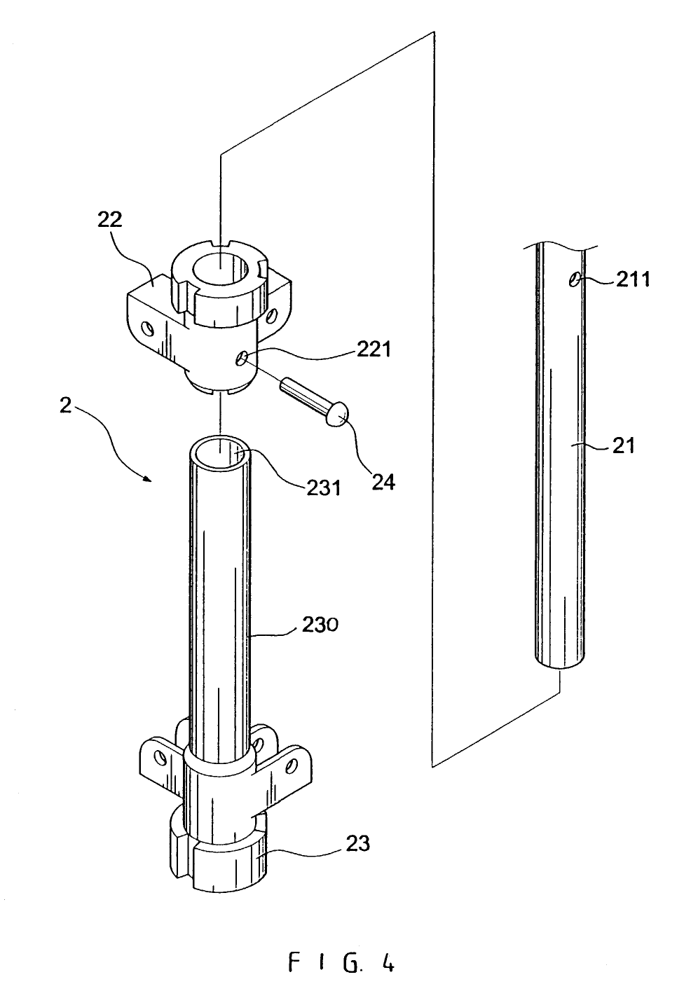

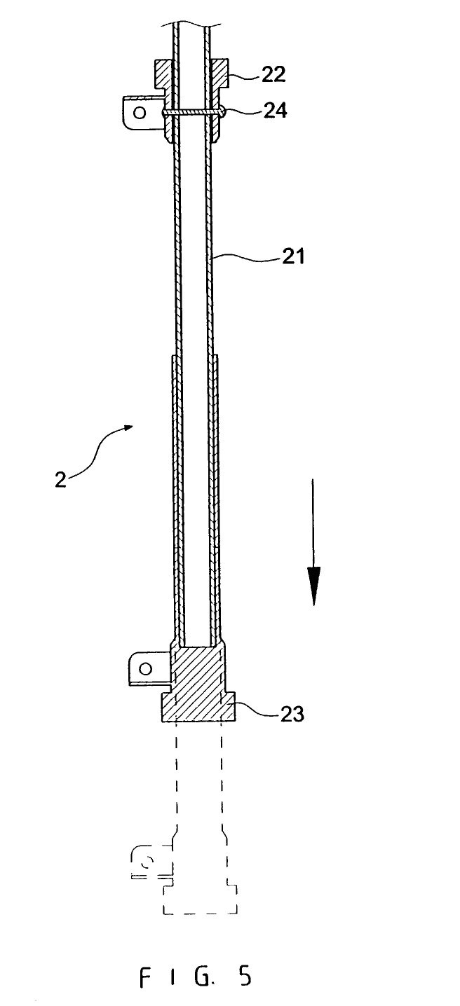

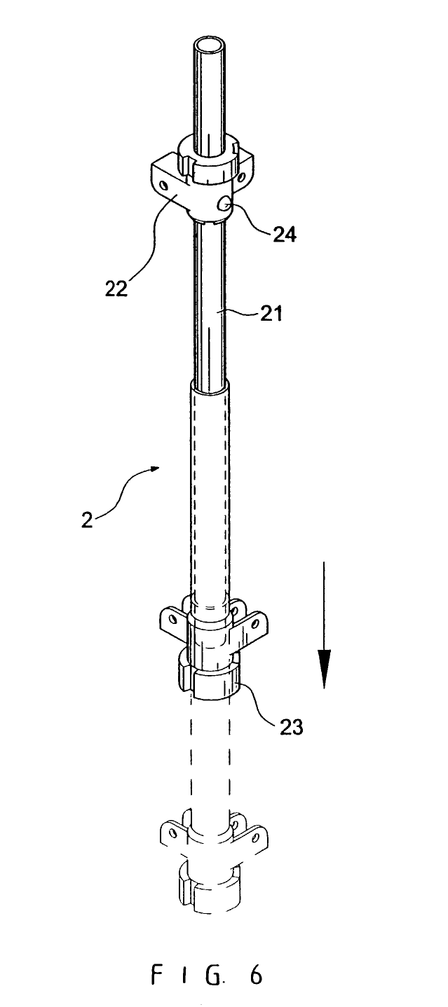

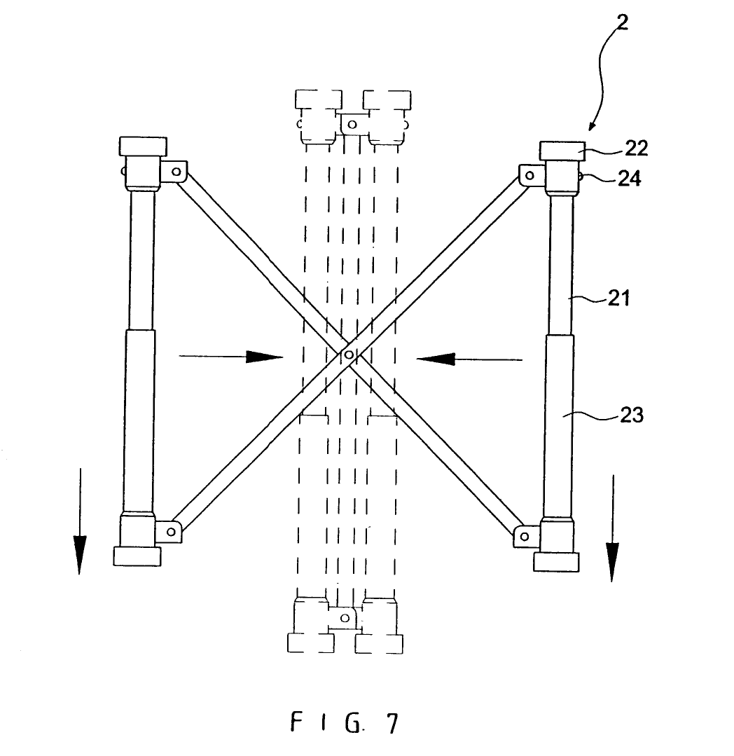

Referring to FIGS. 3 to 7, a first extensible leg frame 2 comprises four support rods 21, four tubes 230, four hollow joints 22, four bottom seats 23, and eight connection rods 3.

Each hollow joint 22 is disposed on a top end of the corresponding support rod 21.

Each tube 230 is disposed on the corresponding bottom seat 23.

Each support rod 21 is inserted through the corresponding tube 230.

Each connection rod 3 is connected to the corresponding hollow joint 22 and the corresponding bottom seat 23.

Each support rod 21 has a round aperture 211.

Each hollow joint 22 has a plurality of circular apertures 221.

A rivet 24 fastens the corresponding hollow joint 22 and the corresponding support rod 21 together.

Each tube 230 has a through hole 231.

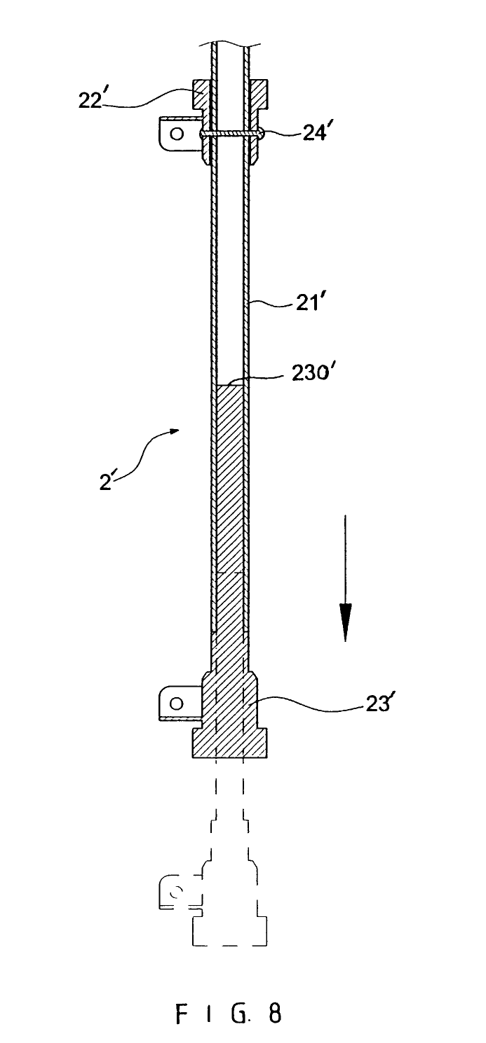

Referring to FIG. 8, a second extensible leg frame 2′ comprises at least a support rod 21′, at least a tube 230′, at least a hollow joint 22′, and at least a bottom seat 23′.

The hollow joint 22′ is disposed on a top end of the support rod 21′.

The tube 230′ is disposed on the bottom seat 23′.

The tube 230′ is inserted in the support rod 21′.

A rivet 24′ fastens the corresponding hollow joint 22′ and the corresponding support rod 21′ together.

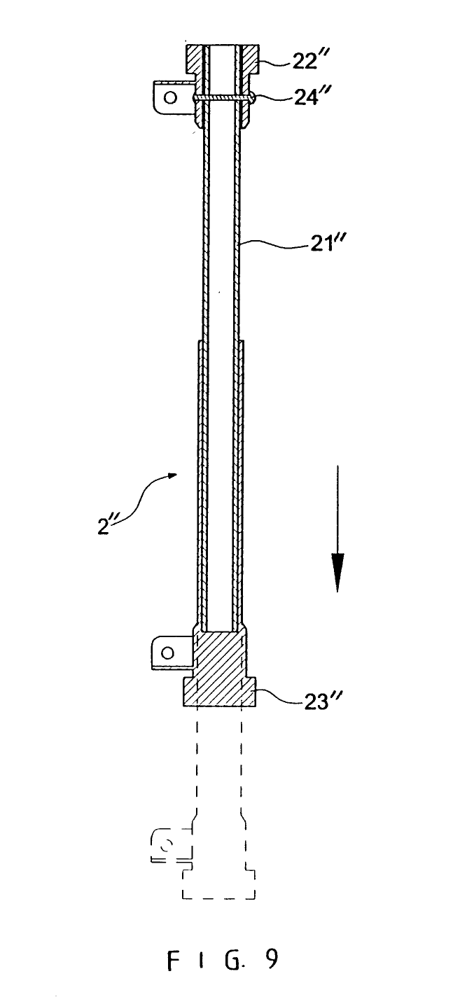

Referring to FIG. 9, a third extensible leg frame 2″ comprises at least a support rod 21″, at least a tube 230″, at least a hollow joint 22″, and at least a bottom seat 23″.

The hollow joint 22″ is disposed on a top end of the support rod 21″.

The tube 230″ is disposed on the bottom seat 23″.

The support rod 21″ is inserted through the tube 230″.

A rivet 24″ fastens the corresponding hollow joint 22″ and the corresponding support rod 21″ together.

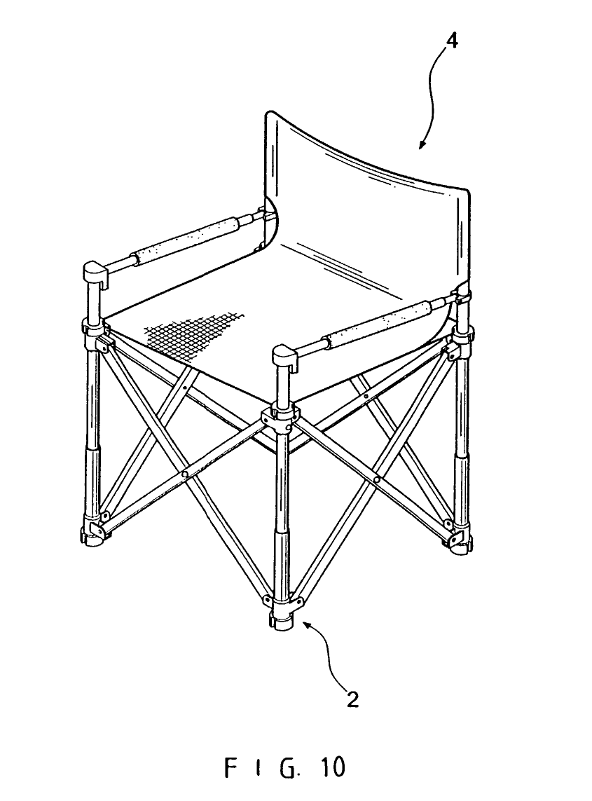

Referring to FIG. 10, a foldable chair seat 4 is disposed on the first extensible leg frame 2.

The invention is not limited to the above embodiment but various modification thereof may be made. Further, various changes in form and detail may be made without departing from the scope of the invention.

I claim:

1. An extensible leg frame comprises:
four support rods, four tubes, four hollow joints, four bottom seats, and eight connection rods,
each said hollow joint disposed on a top end of the corresponding support rod,
each said tube disposed on the corresponding bottom seat,
each said support rod inserted through the corresponding tube,
each said connection rod connected to the corresponding hollow joint and the corresponding bottom seat,
each said support rod having a round aperture, each said hollow joint having a plurality of circular apertures, and
a rivet fastening the corresponding hollow joint and the corresponding support rod together.

2. An extensible leg frame comprises:
at least a support rod, at least a tube, at least a hollow joint, and at least a bottom seat,
the hollow joint disposed on a top end of the support rod,
the tube disposed on the bottom seat,
the tube inserted in the support rod, and
a rivet fastening the hollow joint and the support rod together.

3. An extensible leg frame comprises:
at least a support rod, at least a tube, at least a hollow joint, and at least a bottom seat,
the hollow joint disposed on a top end of the support rod,
the tube disposed on the bottom seat,
the support rod inserted through the tube, and
a rivet fastening the hollow joint and the support rod together.
